(19) United States
(12) Patent Application Publication
(10) Pub. No.: US 2012/0291869 A1
(43) Pub. Date: Nov. 22, 2012

(54) Systems and Methods for Releasing Additive Compositions

(75) Inventors: David Alan Little, Newtown, PA (US); Magesh Sundaram, Chicago, IL (US)

(73) Assignee: Dober Chemical Corporation, Woodridge, IL (US)

(21) Appl. No.: 13/469,983

(22) Filed: May 11, 2012

Related U.S. Application Data
(60) Provisional application No. 61/519,330, filed on May 20, 2011.

(51) Int. Cl. F17D 1/00

(52) U.S. Cl. 137/1; 137/268

(57) ABSTRACT

Systems and methods for releasing additive components into liquid media are provided. The systems include a plurality of coated items and a container holding the coated items. The container includes an insoluble material and a plurality of through holes through the material. The material covers an area of the container greater than the combined area of the through holes.

### RELATED APPLICATION

This application claims the benefit of U.S. Provisional Patent Application No. 61/519,330, filed May 20, 2011, the disclosure of which is hereby incorporated by reference in its entirety by reference.

### FIELD OF THE INVENTION

The present invention relates to systems and methods for releasing additive components, into a liquid medium. More particularly, the invention relates to systems and methods for controlled releasing of additive components into a liquid medium, such as an aqueous liquid medium.

### BACKGROUND OF THE INVENTION

One or more, additives such as anti-foulants, anti-scaling agents, corrosion inhibitors, buffering and pH agents, microbiocides and the like may be added to a liquid medium to prevent fouling, for example, scale deposition, corrosion of metal surfaces and the like caused by the liquid medium, as well as to otherwise condition or treat the liquid medium, for example, to maintain proper pH levels in the liquid medium, to provide a degree of antimicrobial activity to the liquid medium and the like.

Various methods of introducing additives into liquid medium have been developed. For instance, a liquid or solid additive material may be added directly to the liquid medium, for example, liquid aqueous medium. However, this method cannot maintain a steady concentration level of additive within the liquid medium. Initially, there would be a high level of the additive released into the liquid medium, and within a short time the additive may be depleted, for example, to the point where the remaining additive is not effective to perform its intended function. Additionally, a significant draw back of this direct addition method is the danger of initially overdosing the liquid medium with one or more additives. Such overdosing may be dangerous in that it can result in erosion and corrosion problems.

Attempts have been made to address these and other issues by using controlled release coatings. For example, Characklis in U.S. Pat. No. 4,561,981 disclosed a method for controlling, preventing or removing fouling deposits, particularly in pipelines, storage tanks and the like by microencapsulating fouling control chemicals in a slow release coating. The coating material is described as being any material compatible with the fouling control chemical which is capable of sticking to the fouling deposit site. However, the coating materials as disclosed by Characklis may dissolve in a cooling system and create further corrosion problems.

Mitchell et al. in U.S. Pat. No. 6,010,639 discloses that a terpolymer may be used as a coating for cooling additives. Blakemore et al U.S. Pat. Nos. 6,878,309 and 7,883,638, disclose various materials that are useful as coatings for additives.

The disclosure of each and every patent and patent application publication and other publications identified herein is incorporated in its entirety herein by reference.

Although coated additive compositions have provided a substantial advance in controlling the release of additives into liquid media, further improvements would be welcomed. For example, using a mass of coated, additive-containing particles to release additive into a liquid medium passing through a feeder apparatus holding the coated particles has been found to result in controlled release of the additive into the liquid medium over time. However, while the additive release is controlled, the rate of release varies substantially with time. In other words, the rate of release varies substantially over the time the liquid is passing through the feeder apparatus.

This varying rate of release can result in an uneven, or even insufficient or ineffective, treatment of the liquid medium, and can result in the coated particles being prematurely discarded, even though the particles still contain useful amounts of the additives.

Thus, this varying rate of release can cause ineffective treatment of the liquid medium and problems resulting from such ineffective treatment, such as corrosion, unwanted microbial growth and the like; and/or increased treatment costs, since useful, and costly additive(s) are discarded without being released into the liquid medium.

Thus, there is a need for new systems and methods for releasing additive components into liquid media.

### SUMMARY OF THE INVENTION

New systems and methods for releasing additive components into liquid media have been discovered. The present systems and methods may provide one or more benefits, for example, relative to previous practice. In one example, the present systems and methods provide a more uniform rate of additive release into a liquid medium. This feature is important since a more uniform rate of additive release effectively provides the desired release of the additive over time to provide a more uniform level of treatment of the liquid medium. Thus, the quality or condition of the liquid medium is more easily controlled over time. Also, since the additive release rate is more uniform, it becomes easier to determine when the additive in the system has been exhausted, so that a new supply of additive can be added at the proper time, rather than replacing the additive supply prematurely—with a relatively large amount of additive still unused.

In one example of the present invention, a system for releasing an additive component is provided and comprises a plurality of coated items and a container holding the plurality of coated items. The plurality of coated items may comprise a core comprising an additive component effective to treat liquid medium when released into the liquid medium, and a coating substantially surrounding the core and effective to slow the release of the additive component into the liquid medium. The coating may be substantially insoluble in the liquid medium. The container may comprise a material substantially insoluble in the liquid medium and a plurality of through holes through the material. The material may cover an area of the container greater than the combined area of the plurality of through holes. In one example, the release rate of the additive component from the plurality of coated items into a liquid medium in contact with the container is more uniform over time relative to a reference release rate of an identical additive component from an identical plurality of identical coated items held in an identical container in which the material covers an area of the container less than the combined area of the plurality of through holes.

In one example, the release rate of the additive component from the plurality of coated items is more uniform over time relative to a reference release rate of an identical additive component from an identical plurality of identical coated items held without the container in an open mesh basket. As used herein, the term “open mesh basket” refers to a receptacle or containment device comprising a network of solid members, for example, relatively thin or narrow solid members, arranged so as to define a plurality of through openings therebetween, wherein the area covered by the solid members is less than the combined area of the through openings.

In one example, the material covers an area of the container at least about 1.5 times the combined area of the plurality of through holes. The material may cover an area of the container at least about 2 times or at least about 3 times or at least about 5 times or at least about 7 times or at least about 9 times the combined area of the plurality of through holes.

The number of through holes in the container may vary over a wide range depending on various factors, such as the desired additive release rate, the flow rate of the liquid medium in contact with the container, the temperature and other process conditions present, other factors and the like. In one example, the plurality of through holes comprises at least about 5 through holes. The number of through holes may be at least about 10, or at least about 20, or at least about 50 or at least about 100 or more per container.

The plurality of through holes may be sized to prevent the plurality of coated items from passing out of the container through any of the through holes.

In one example, the area of each of the plurality of through holes is less than the average minimum cross-section area of the plurality of coated items.

The average area of the plurality of through holes may be at least about 0.1 square inch or at least about 0.2 square inch.

In one example, the container includes no more than about 6 through holes per square inch of container. In one example, the container is not an open mesh basket with thin or narrow solid members defining through openings therebetween.

In one example, the container, except for the plurality of through holes, is closed. In this example, the only paths in and out of the container are through the plurality of through holes.

In one example of the present invention a method for releasing an additive component comprises contacting the container holding the plurality of coated items, as described herein, with a liquid medium, thereby releasing the additive component into the liquid medium. Any suitable liquid medium may be treated in accordance with the present invention. The additive component may be soluble in the liquid medium. The liquid medium may be substantially water, an aqueous liquid medium, a non aqueous liquid medium, an organic liquid medium and the like.

Various examples of the present invention are described in detail in the detailed description and additional disclosure below. Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any example of the present invention.

These and other aspects and advantages of the present invention will become apparent in the following detailed description, claims and drawings, in which like parts bear like reference numerals.

### BRIEF DESCRIPTION OF THE DRAWINGS

FIG. 1 is a side view of one example of an additive component release system in accordance with the present invention.

FIG. 1A is a schematic side view of another example of an additive component release system in accordance with the present invention.

FIG. 1B is a schematic side view of an additional example of an additive component release system in accordance with the present invention.

FIG. 1C is a schematic side view of a further example of an additive component release system in accordance with the present invention.

FIG. 2 is a cross-sectional view, taken along line 2-2 of FIG. 1, of the system shown in FIG. 1.

FIG. 3 is a front view of a cylindrical coated particle included in the system of FIG. 1.

FIG. 4 is a cross-sectional view, taken along line 4-4 of FIG. 3, of the coated particle shown in FIG. 3.

FIG. 5 is a schematic illustration showing the system of FIG. 1 in use.

FIG. 6 is a graphical illustration of a release rate comparison from orthophosphate-containing coated tablets held in a system in accordance with the present invention and identical tablets held in an open mesh basket (OMB).

FIG. 7-10 are illustrations of several specific examples of tubular elements or bags useful in the additive component release systems in accordance with the present invention.

FIG. 11 is a plan view of a portion of an elongated sheet of polymeric material useful in producing systems in accordance with the present invention.

### DETAILED DESCRIPTION OF THE INVENTION

The present invention relates to systems for releasing additive components into liquid media, and to methods for using such systems for releasing additive components.

The present systems and methods effectively provide for release of additive components from the systems into liquid media, for example, aqueous liquid media, e.g., liquid media comprising water or water and at least one component other than water, for example, and without limitation, a freezing point depressant, such as at least one glycol and the like and mixtures thereof; non-aqueous liquid media, for example, liquid medium substantially free of water; and the like.

The systems of the present invention may be used in any application in which it is beneficial, or otherwise useful, to release one or more additive components into a liquid medium or composition. Such applications include, for example, and without limitation, cooling applications, such as treating recirculating cooling water in industrial and commercial cooling systems; fungi and/or algae control applications; potable water system treating applications; reverse osmosis system treating applications; swimming pool treating applications; spa and hot tub treating applications; down hole drilling treating applications; enhanced oil recovery treating applications; air washer, such as industrial air washer, system treating applications; aqueous and non-aqueous metal working fluid treating applications; food processing applications, e.g. food, such as egg and/or other food stuffs, washing applications; pulp and paper mill treating applications; brewery pasteurizer water treating applications; industrial preservation applications; publicly owned water treatment applications; fracturing fluid heating applications; and the like.

Additional applications of the present systems and methods include, for example, and without limitation, treating industrial liquid media in or associated with heavy equipment, including both stationary and mobile equipment; treating open circulating or recirculating coolant or cooling systems, such as cooling towers and the like; treating humidification systems, spray water systems, fire quench tanks, and storage tanks, such as fuel storage tanks and other storage tanks; treating industrial recirculating closed cooling systems; treating process fluid systems, such as cutting and/or other machining oil systems, heating fluid systems, for example, thermal heating fluid systems, and the like. The systems and methods of the present invention may be used in other applications.

The systems of the present invention may be employed by placing the container or containers in an appropriate position, for example, in or near an application system or liquid composition to be treated, so that additive composition or additive compositions from the present systems are released into the liquid composition to be treated, for example, in the application system to be treated.

In one example, the present systems comprise a plurality of coated items comprising a core comprising an additive component effective to treat a liquid medium when released into the liquid medium; and a coating substantially surrounding the core and effective to slow the release of the additive component into the liquid medium; and a container holding the plurality of coated items. The container may comprise a material substantially insoluble in the liquid medium into which the additive component is to be released and a plurality of through holes, for example, at least about 5 or at least about 10 or at least 20 or at least 50 or more through holes through the material.

Any suitable coating which provides the desired additive component release properties may be used in the present invention.

In one example, film forming polymers may be employed. Suitable film forming polymers may include, for example, and without limitation, homopolymers, copolymers and mixtures thereof, wherein the monomer units of the polymers are preferably derived from ethylenically unsaturated monomers, for example, one, two or more different such monomers.

One example of an ethylenically unsaturated monomer is compound I with the formula (R₁) (R₂) (R₃)C—COO—(CH═CH₂), wherein R₁, R₂ and R₃ are saturated alkyl chains. In one example, R₃ of compound I is CH₃, and R₁ and R₂ of compound I have a total of about 2 to about 15 carbons. Such a molecule is known as a vinylversatate. In one example, R₃ is CH₃, and R₁ and R₂ have a total of about 5 to about 10 carbons. In one example, R₃ is CH₃, and R₁ and R₂ have a total of 7 carbons.

In one example, the polymer forming the coating is made up of a copolymer of vinylacetate and vinylversatate. About 45% to about 95%, for example, about 65%, by weight of the units of the copolymer may be from vinylacetate and about 5% to about 55%, for example, about 35% by weight of the units of the copolymer may be from vinylversatate.

In one example, the vinylversatate used is sold under the trademark VEOVA 10 sold by Shell Chemicals. In one example, the water-based emulsion polymer is a vinylacetate-vinylversatate copolymer, sold under the trademark EMULTEX VV675 sold by Harlow Chemical Co. (England). Additionally, a surfactant may also be added to stabilize the dispersion. In one example, the polymer solid in the dispersion is about 54% to about 56% by weight of active polymer solid.

In one example, a copolymer which may be used as a coating in accordance with this invention includes acrylate derived units and vinylversatate derived units. NeoCAR 2535 sold by Union Carbide is an example of a useful acrylate-vinylversatate copolymer.

In one example, a polymer used in forming a coating in accordance with this invention is made up of a copolymer of vinylacetate and ethylene. In one example, about 45% to about 95% by weight of the units of the copolymer are from vinylacetate and about 5% to about 55% by weight of the units of the copolymer are from ethylene. In one example, about 60% to about 80% by weight of the units of the copolymer are from vinylacetate and about 30% to about 40% by weight of the units of the copolymer are from ethylene. In one example, about 90% by weight of the units of the copolymer are from vinylacetate and about 10% by weight of the units of the copolymer are from ethylene. A controlled release additive composition useful in the present invention may comprise about 5% to about 15% of a vinylacetate-ethylene copolymer.

In one example, a copolymer comprising vinylacetate and ethylene may be purchased under the trade name AirFlex 410, sold by Air Products and Chemicals, Inc., Allen Town, Pa., U.S.A. Such copolymer may have a viscosity of about 250 to about 900 cps.

In one example, the polymer for coating is made up of a homopolymer. The monomer unit of the homopolymer may be ethylcellulose, and may be purchased from Dow Chemical sold under the trademark ETHOCEL S10, S20, S45 and S100.

In one example, the coating comprises a polymeric component selected from (1) polymers including units, for example, repeating units, from vinyl acetate, ethylene, and vinyl chloride, (2) polymers including units, for example, repeating units from vinyl acetate, an acrylate ester, and at least one monomer selected from vinyl neopentanoate, vinyl neohexanoate, vinyl neoheptanoate, vinyl neooctanoate, vinyl neonananoate and vinyl neoundecanoate. Such polymeric components are described in Sundaram et al U.S. Pat. No. 7,883,638.

Another group of polymers which my be used are the polymers, such as terpolymers, including units from vinyl acetate, acrylate esters, including, for example, lower alkyl, such as alkyl containing 1 to about 6 carbon atoms, acrylates and lower alkyl methacrylates, and at least one of certain vinyl neoalkanoates. As used herein, the term “lower alkyl” includes methyl, ethyl, propyl, butyl, pentyl, hexyl and the like.

The additive component useful in the present invention may comprise one or more, e.g., a mixture of, conventional inhibiting and buffering agents typically used in aqueous systems, such as cooling systems, for example, open circulating or recirculating cooling water systems. In one example, the additive component comprises one or more of (1) a buffering component to maintain a neutral or alkaline pH, including for example, alkali metal salts or sodium phosphates, borates and the like, (2) a cavitation liner pitting inhibitor component, including for example, alkali metal or sodium nitrites, molybdates and the like, (3) a metal corrosion and hot surface corrosion inhibitor component, including for example, alkali metal, salts of nitrates, nitrates and silicates, carboxylic acids, phosphonic acids, phosphonate, pyrophosphate, azoles, sulfonic acids, mercaptobenzothiazoles, and the like, (4) a defoaming agent component including, for example, and without limitation, silicone defoamers, alcohols such as polyethoxylated glycol, polypropoxylated glycol or acetylenic glycols and the like, (5) a hot surface deposition and scale inhibitor component including for example, and without limitation, phosphate esters, phosphino carboxylic acid, polyacrylates, styrene-maleic anhydride copolymers, sulfonates and the like, (6) a scale and corrosion inhibitor component including, but not limited to 1-hydroxyethylidene diphosphonic Acid (HEDP), 2-phosphonobutane-1,2,4-tricarboxylic acid (PBTC), hydroxyphosphonoacetic acid (HPA), maleic acid copolymer (such as that sold under the tradename Belclene 283), polyacrylic acid, sulfonated copolymers (such as those sold under the tradename Aquatreat® AR 540, and Acumer 3100), disodium phosphate, monosodium phosphate, potassium tripolyphosphate, sodium hexametaphosphate, tolyltriazole, benzotriazole, sodium molybdate, zinc salts, such as zinc chloride, and the like; (7) a dispersing component, including, for example, and without limitation, non-ionic and/or anionic surfactants such as phosphate esters, sodium alkyl sulfonates, sodium aryl sulfonates, sodium alkylaryl sulfonates, linear alkyl benzene sulfonates, alkylphenols, ethoxylated alcohols, carboxylic esters and the like, (8) an organic acid, including, for example, and without limitation, adipic acid, sebacic acid and the like, (9) an anti-gel additive, such as that disclosed by Feldman et al in U.S. Pat. No. 5,094,666, and (10) one or more other components, for example, and without limitation dyes, pH modifiers (e.g., sulfamic acid) surfactants or surface active agents, deposit penetrants and the like, (11) microbiocides, such as microbiocides used in open circulating cooling water systems of cooling towers, for example, as disclosed by PCT Publication No. US2009/003228). Such microbiocides include, but are not limited to, chlorine-containing microbiocides, bromine-containing microbiocides, and the like and combinations thereof.

In one example, the additive component includes one or more nitrite compounds. In a preferred embodiment, the additive component includes a mixture of nitrite compounds and molybdate compounds to maintain a minimum concentration level of about 800 ppm of nitrite or a mixture of nitrite and molybdate in the cooling system, with the proviso that the minimum level of nitrite in the cooling system is about 400 ppm. The additive may include one or more borate, silicate, organic acids, tolytriazole, scale inhibitors, surfactants and defoamers and the like, for example, in addition to nitrite and molybdate.

In one example, the additive component includes a mixture of nitrite, nitrate and molybdate compounds. In one example, the additive component may include one or more nitrite, nitrate, phosphate, silicate, borate, molybdate, tolyltriazole, organic acids, scale inhibitors, surfactants, defoamers and the like.

The additive component may be in solid, granular or particulate form provided that it does not decompose or melt at processing temperatures. Preferably, the additive component is molded in the form of a pellet or tablet which may have any suitable shape, for example, and without limitation, a spherical shape, a cube shape, an irregular shape and the like. Generally, a spherical pellet or tablet should have a diameter on the order of from about 1/32″ to about 5.0″, preferably from about 2/32″ to about 3″, more preferably from about ⅛″ to about ½″, even more preferably about ⅜″.

The formation of the additive component into a pellet or tablet is dependent upon the mixture of materials contained therein. For example, when the additive component contains a sufficient amount of a dispersing agent or a mixture of dispersing agents, the dispersing agent or mixture also may function as a binder, thereby allowing the component to be molded or compressed directly into the form of a pellet or tablet. If the additive component does not compact well, a binder must be added to the additive component in order to mold or compress it into a pellet or tablet. Suitable binders include, for example, polyvinyl pyrrolidone, sodium acrylate, sodium polyacrylate, carboxymethylcellulose, sodium carboxylnethylcellulose, corn starch, microcrystalline cellulose, propylene glycol, ethylene glycol, sodium silicate, potassium silicate, methacrylate/acrylate copolymers, sodium lignosulfonate, sodium hydroxypropylcellulose, preferably hydroxyethylcellulose, and water.

Preferably, the additive component to be molded or compressed into a pellet or tablet further comprises a die release agent. Suitable die release agents include, for example, calcium stearate, magnesium stearate, zinc stearate, stearic acid, propylene glycol, ethylene glycol, polyethylene glycol, polypropylene glycol, polyoxypropylene-polyoxyethylene block copolymers, microcrystalline cellulose, kaolin, attapulgite, magnesium carbonate, fumed silica, magnesium silicate, calcium silicate, silicones, mono- and dicarboxylic acids and corn starch.

To form a controlled release cooling additive composition, the polymeric coating may be applied to the additive composition core by spray coating, microencapsulation or any other coating technique well known to practitioners in the art. The polymeric coating may be an aqueous dispersion latex which is applied to the additive core pellet or tablet by drum or pan coating. The amount of coating to be applied to the additive core may be dependent upon the desired controlled release characteristics of the resulting coated item. An increase in the amount of coating may result in a decrease of the rate of release of the additive component. The weight percent of the coating may be in a range of about 1% to about 40% based on the total weight of the coated item, for example, about 2% to about 20% by weight or about 3% to about 15% by weight of the coated item.

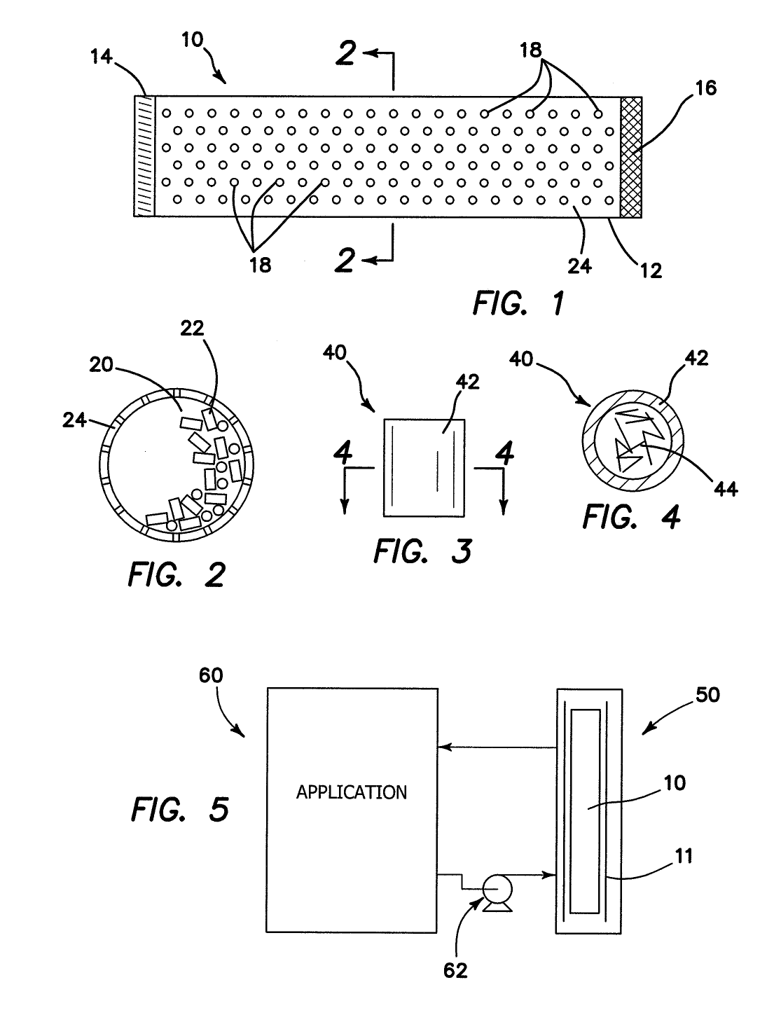

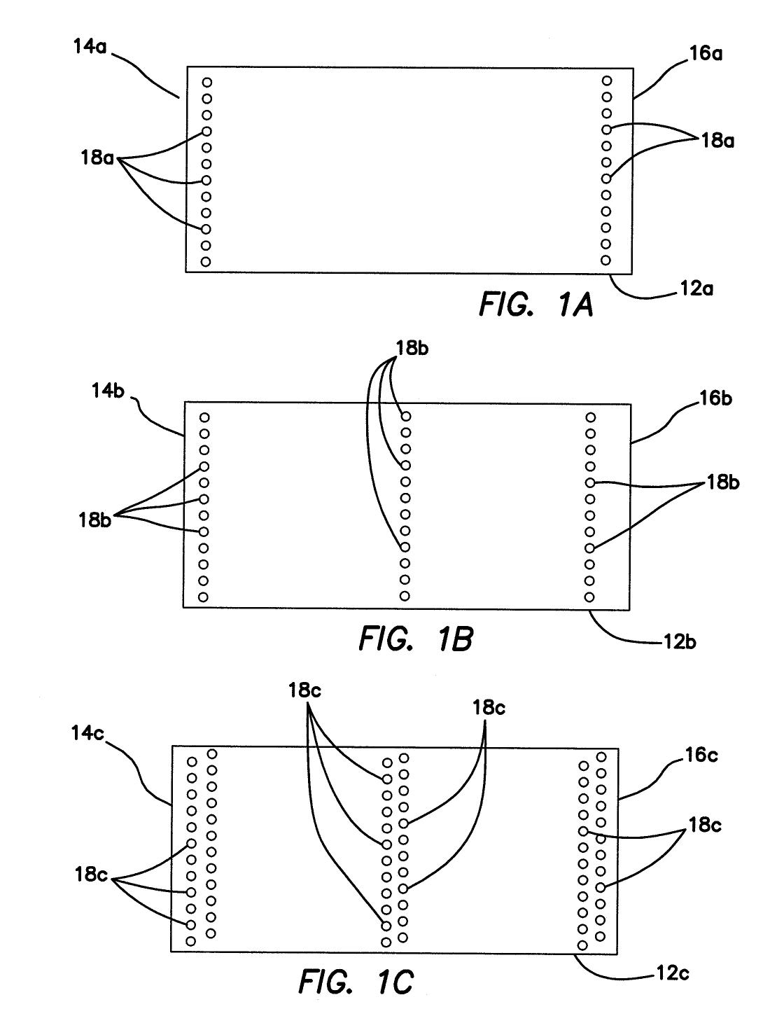

Referring now to the drawings, FIGS. 1 and 2 illustrate an example of an additive release system 10 in accordance with the present invention.

System 10 comprises a hollow tubular element or bag 12 which is sealed, for example, heat sealed, adhesively sealed and the like, at the first end 14 and the second end 16 of the element 12. In one example, a removable, e.g., rotatable end piece may be provided at one or both ends 14 and 16. The end piece or pieces may be removed from the tubular element 12 to refill the tubular element with coated items containing additive component, thereby allowing tubular element 12 to be reused.

Although element 12 is illustrated, for example, see FIG. 2, as a substantially circular cylindrical tube, this configuration is not limiting. In other words, element 12 may be provided in any suitable configuration and size, for example, suitable to function effectively or acceptably in the application in which system 10 is to be used. Element can have other cross-sections, such as square, rectangular, triangular, a curved cross-section other than circular, an irregularly shaped cross-section and the like. Near the first and second ends 14 and 16, the cross-section of the element may transition to a substantially linear cross-section at the first and second ends.

The size of element 12 may range widely, for example, and without limitation, having a hollow interior space 20 with a volume in a range of about 0.5 cubic inches or less to about 1500 cubic inches or more, or about 1 cubic inch to about 1000 cubic inches or about 5 cubic inches to about 500 cubic inches or about 20 cubic inches to about 500 cubic inches or more. In one example, tubular elements, such as bags, have hollow interior spaces with volumes in a range of about 105 cubic inches to about 380 cubic inches.

Element 12 may be considered a container, for example, a bag, holding a plurality of coated items 22.

A plurality of through holes 18 extend through the tubular element 12 into the hollow interior space 20 (shown in FIG. 2) within the tubular element.

The material from which tubular element 12 is made may be insoluble or substantially insoluble in the liquid medium into which system 10 is to release an additive component, for example, one or more additives. For example, if the liquid medium is water or a water-containing liquid medium, e.g., an aqueous liquid medium, the material may be insoluble or substantially insoluble in water or in the aqueous liquid medium.

In addition, the material from which tubular element 12 is made may be compatible with the additive component and the coating for the additive component in the hollow interior space 20. For example, the material from which element 12 is made may be substantially inert, for example, substantially unaffected by, and causing no substantial or significant detrimental effect to, the additive component and coating. The material from which element 12 is made, the additive component and the coating may be selected so that each may effectively perform its function without undue interference from the others.

The container may comprise a material substantially insoluble in the liquid medium, for example, an aqueous liquid medium, and a plurality of through holes through the material. The material may cover an area of the container greater than the combined area of the plurality of through holes. In one example, the release rate of the additive component from the plurality of coated items into a liquid medium in contact with the container is more uniform over time relative to a reference release rate of an identical additive component from an identical plurality of identical coated items held in an identical container in which the material covers an area of the container less than the combined area of the plurality of through holes.

In one example, the material covers an area of the container at least about 1.5 times or at least about 2 times or at least about 3 times the combined area (open area) of the plurality of through holes.

The material from which element 12 is made may be any suitable material effective to allow the element to effectively function, for example, as described herein. Examples of useful materials from which element 12 may be made include, without limitation, metals, glasses, ceramics, polymeric materials and the like and combinations thereof.

In one example, the element 12 is made of a material having a degree of flexibility. In one example, the element is at least partially collapsible, for example, as the additive component is released into the liquid medium.

The element 12 may have a unitary or single piece structure. The element 12 may be reusable or disposable, for example, having a unitary structure to be disposed of after a single use.

In one example, the material from which the tubular element 12 is made may be a polymeric material, for example, a flexible polymeric material. The polymeric material may be a thermoplastic polymeric material.

The use of elements, such as tubular element 12, made of such polymeric materials may provide advantages, such as reduced cost, ease of manufacture and use, effectiveness in use and disposal.

Examples of useful polymeric materials from which tubular element 12 may be made include, without limitation, polyolefins and the like and mixtures thereof and combinations thereof. Polyethylene, polypropylene and the like and mixtures thereof and combinations thereof may be used. Tubular element 12 may be made of one or more other polymeric materials.

The size, for example, diameter and length, and volume of the hollow interior space 20 of the tubular element 12 may be selected to accommodate the needs of the application in which system 10 is to be used. For example, the size of element 12 may be selected to be consistent with the amount of additive component which is to be included in the hollow interior space 20, and the size of the feeder assembly, if any, to be used with the system 10 and the like factors which may be specific to the application in which tubular element 12 is to be used. For example, and without limitation, the tubular element 12 may have an inside diameter in a range of about 1 inch to about 6 inches or more, such as about 2 inches to about 4 inches. The tubular element 12 may have an inside diameter of about 2.6 inches or about 2.8 inches or about 3.8 inches or about 4 inches. The tubular element 12 may stretch to some extent under load so that the inside diameter of the tubular element 12 may be somewhat greater or larger when the element is filled with the coated items.

Without limitation, the length of the tubular element 12 may be in a range of about 1 inch or about 2 inches or about 3 inches or about 5 inches to about 15 inches or about 30 inches or more, for example, about 5 inches to about 30 inches or about 10 inches to about 15 inches.

The thickness of the material from which the tubular element 12 may be selected to allow the weight of the coated items 22 inside the hollow interior space 20 to be held or carried without breaking or tearing the tubular element 12. The tubular element 12 may have a sidewall 24 with a thickness in a range of about 0.001 inch (1 mil) or less to about 0.01 inch (10 mils) or more, for example, about 0.002 inch (2 mil) to about 0.005 inch (5 mil).

The size and configuration or pattern of the plurality of through holes 18 in (through) element 12 may be selected to meet the needs or requirements of the application in which system 10 is to be used. The size and spacing of through holes 18 shown in FIG. 1 is illustrative of one example of such size and configuration or pattern. The gap or distance between each through hole 18 and the nearest other through hole 18 may be in a range of about 0.25 inch to about 1 inch or more, or about 0.3 inch to about 0.6 inch. Such gaps of 0.375 inch and 0.5 inch may be employed.

The through holes 18 may be in one or more rows, for example, horizontal rows as shown in FIG. 1, and/or in vertical rows. One row of through holes 18 or more than one row of through holes 18 may be employed. The through holes 18 may be substantially evenly distributed across the sidewall 24 of the tubular element 12, as shown in FIG. 1, or may be substantially unevenly distributed across the sidewall 24 of the tubular element 12.

In one example, shown schematically in FIG. 1A, through holes 18a are placed in a vertical row through tubular element 12a near the first end 14a and the second end 16a. No through holes are located between the through holes 18a near the first and second ends 14a and 16a.

In one example, shown schematically in FIG. 1B, through holes 18b are placed in a vertical row through tubular element 12b near the first end 14b and the second end 16b and in the middle of the tubular element 12b substantially equidistant between first and second ends 12b and 16b.

In one example, shown schematically in FIG. 1C, through holes 18c are placed through tubular element 12c, with two vertical rows of through holes 18c near the first end 14c, two vertical rows of through holes 18c near the second end 16c, and two vertical rows of through holes 18c in the middle of the tubular element 12c substantially equidistant between first and second ends 14c and 16c.

The configurations of the through holes shown in FIGS. 1, 1A, 1B and 1C are not limiting. The configuration or pattern of the through holes may be selected to at least assist in providing or to be effective in providing the desired release, for example, a more uniform release (as is discussed elsewhere herein) of the additive component into a liquid medium.

Various factors, for example and without limitation, such as the application involved, the liquid medium involved, the additive component and/or coating involved, the flow rate of liquid medium, other conditions to which the system is exposed and the like factors, may affect the release of the additive from the system. The number, size and configuration or pattern of the through holes in the tubular element 12 may be selected or chosen to take into account the effect or effects of one or more or all of these factors, and possibly one or more other factors, to provide the desired additive component release. The through holes may be circular, square, rectangular triangular, polygonal and the like in shape. The through holes can all have the same shape or be comprised of through holes having two or more different shapes.

The through holes, for example, 18, 18A, 18B and 18C, can be provided in tubular element 12 in any suitable way. In one example, the through holes are formed by using a conventional punch or stamping machine to punch or stamp the through holes through the side wall of the element, such as sidewall 24 of tubular element 12.

In one example, a roll, for example, about 100 feet or about 500 feet or more long, of flat stock of polymeric material is provided and is fed to a conventional tube shaping machine. This machine shapes the flat stock into a tube, for example, using a round shaped tubular form of the proper or selected outside diameter. The machine also fuses the sides of the flat stock together in forming the tube. One end of the tube is sealed, and through holes are produced in the tube. The tube is then filled with the coated, additive component-containing items, and the other end of the tube is then sealed. This process is repeated in making individual bags. The individual filled bags are separated, e.g., cut, from each other, and ready for shipment, storage and/or use.

The machine may include a punch or stamping station where the desired through holes may be punched or stamped in the tube at the desired location(s). In one example, the through holes, may be punched or stamped into the polymeric material, e.g., the flat stock of polymeric material prior to forming the tube. The tube, with the through holes, may then be passed to a filling station where a desired amount of coated, additive component-containing items is placed in the hollow interior space formed within the tube. Using conventional equipment, heat and/or adhesive may be applied to the tube at appropriate spaced apart regions to isolate individual increments of the coated items between sealed end regions. The tube is then cut at or near each of these sealed end regions to form individual coated item-filled tubular elements, for example, tubular element 12, for use in releasing the additive component, as described elsewhere herein.

Other methods for producing the systems in accordance with the present invention may be used.

The amount of weight of the coated items 22 to be included within tubular element 12 may depend, for example, on the size or volume of the interior space 20 of element 12, on the requirements of the application, on the strength of the tubular element 12 and the like factors. In one example, the amount of coated items 22 may range from about 1 pound or less to about 5 pounds or about 10 pounds or more. The amount of coated items 22 may range from about 1.5 pounds to about 4 pounds, for example, about 2.2 pounds or about 2.5 pounds.

The coated items may be sized so as to remain contained in the hollow interior space 20 after being placed in the hollow interior space and before the system 10 is used in the use application.

In one example, the coated items are substantially cylindrical tablets, such as coated tablet 40, shown in FIGS. 3 and 4. Coated tablet 40 has a length of about 1 inch and a circular cross-section about 0.5 inch in diameter.

Coated tablet 40 includes a controlled release coating 42, which substantially surrounds a core 44 comprising an additive component, for example, one or more additives, many of which are described elsewhere herein. Examples of useful additives may include, among others, HEDP (1-hydroxyethylidene), PBTC (phosphonobutane-1,2,4-tricarboxylic acid), BZT (benzotriazole), orthophospate, polyacrylate, sulfonated copolymer and mixtures thereof.

FIG. 5 is a schematic illustration of how system 10 is employed to provide additive to an application, for example, an open recirculating cooling tower.

The system 10 is placed in a conventional additive feeder 50. Water is circulated from the application 60 by pump 62 into feeder 50.

The system 10 may be placed directly in the feeder 50. Alternately, as shown in FIG. 5, the system 10 is placed in an inner basket 11 which may assist in maintaining the system 10 in place.

In any event, water from pump 62 passes into feeder 50 and comes into contact with system 10. Over time it is found that system 10 provides a more uniform release of the additive into the water in feeder 50 so that the water in application 60 is provided with a more uniform additive treatment relative to the release and treatment obtained using an identical amount of identical coated items in an identical feeder to provide additive to an identical application except that the tubular element is not present.

### Examples

Two equal masses of identical coated tablets were used for testing. These tablets were in the form of cylinders. Each tablet included a core comprising an additive component consisting of HEDP, PBTC, BZT, and polymer. The core was surrounded by a polymeric coating of a copolymer including acrylate derived units and vinylversatate derived units sold under the tradename Neocar 2535 by Union Carbide. The coating was designed to slow the release of the additive component into water.

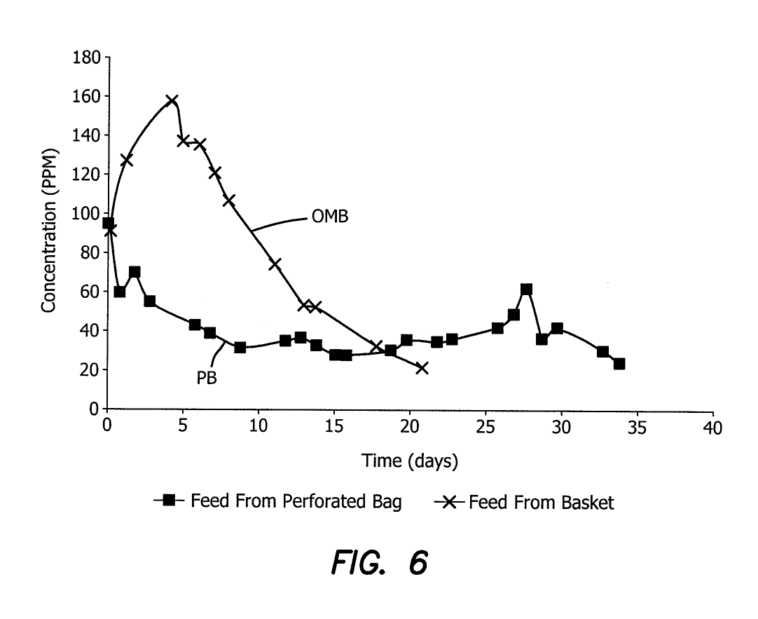

One mass of tablets (Mass A) was placed in an open mesh basket. The basket was such that more than 50% of the surface of the basket was open. The coated tablets of Mass A in the open mesh basket was placed in a system in which the coated tablets in the open mesh basket were contacted with a recirculating flow of water at a temperature of 80° F.±1° F. for 21 days. Periodically, during this time, the water in the sump of the recirculating water system was monitored for treatment level by a phosphonate test; results reported as orthophosphate content in parts per million (ppm). Results of this monitoring are graphically shown in FIG. 6 by curve OMB.

An identical mass of tablets (Mass B) was placed in a container, as shown and described in FIG. 1. The container or bag was such that more than 50%, for example, about 78.5%, of the surface of the bag was closed, that is the surface of the bag included more solid material than the combined area of the through openings.

This mass of tablets (Mass B) in this container was placed in an identical system at the same conditions as noted above with regard to Mass A. The mass of coated tablets (Mass B) in this container were contacted in a recirculating flow of water at a temperature of 80° F.±1° F. for 34 days. Periodically, during this time, the water in the sump of the recirculating water system was monitored for treatment level by a phosphonate test; results reported as orthophosphate content. Results of this monitoring are graphically shown in FIG. 6 by curve PB.

Comparing curves OMB and PB shows that for the first about 7 days, the release rate of orthophosphate from the Mass A tablets in the open mesh basket was substantially greater than the release rate from the Mass B tablets in the container (bag).

Importantly, the release rate from the Mass B tablets was more uniform over the period of testing than was the release rate from the Mass A tablets.

The Mass B tablets in the container (bag) released an effective amount of orthophosphate for 34 days whereas the Mass A tablets in the open mesh basket released an effective amount (on a daily basis) for only 21 days.

The ability to provide a more uniform release rate and/or to maintain a controlled release of an effective amount of additive component (orthophosphate) over a longer period of time provides substantial benefits, for example, more effective use of the additive component, longer useful life of the mass of coated tablets, and reduced costs in having to replace the coated tablets less frequently. The results illustrated in FIG. 6 demonstrate that the Mass B coated tablets in a container (bag) in accordance with the present invention provide a more uniform additive component release rate and release an effective amount of additive component for a longer period of time relative to the Mass A coated tablets in an open mesh basket.

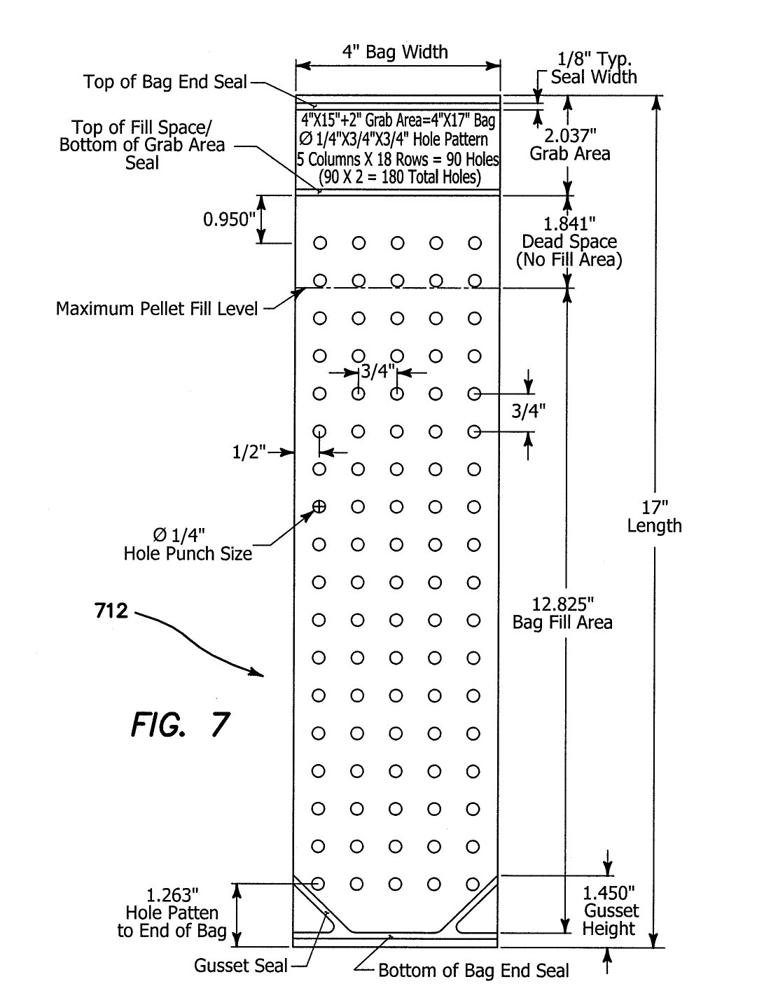

FIGS. 7-10 show four different tubular elements 712, 812, 912 and 1012, respectively, useful in the present additive component release systems. Unless otherwise expressly described herein or in the drawings, tubular elements 712, 812, 912 and 1012, are structured and function substantially similarly to tubular element 12.

As shown in FIGS. 7-10, the tubular elements 712, 812, 912 and 1012 are laid flat on the plane of the paper. Thus, as shown, tubular elements 710, 810, 910 and 1012 are not filled with coated items.

The tubular element 710 in FIG. 7 may be considered Option 1.

In Option 1, the hole (through hole) pattern is close to the bottom end of the tubular element or bag; a large dead space is provided between the top of the pellets or tablets and the top of the fill space of the tubular element or bag; and the overall length of the tubular element or bag is increased or extended, for example, by about one inch, so that the device, e.g., a grabber, that seals the ends of the bag, after filling the bag with the pellets or tablets, is not hindered from performing this function by the presence of the pellets or tablets inside the bag.

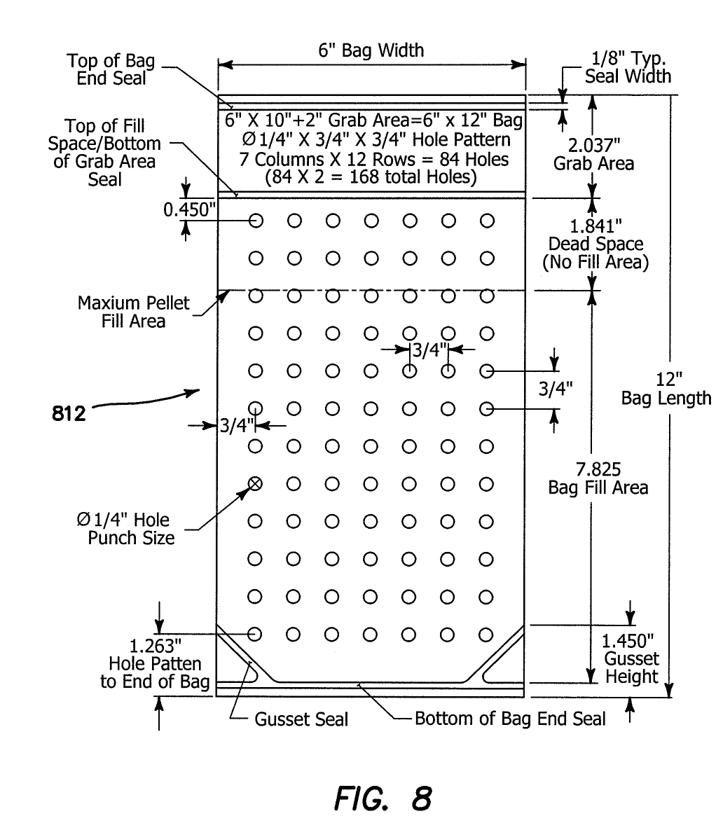

The tubular element 810 in FIG. 8 may be considered Option 2.

Option 2 is similar to Option 1, except that the width of the tubular element or bag is larger than in Option 1 and the length of the tubular element or bag is smaller than in Option 1.

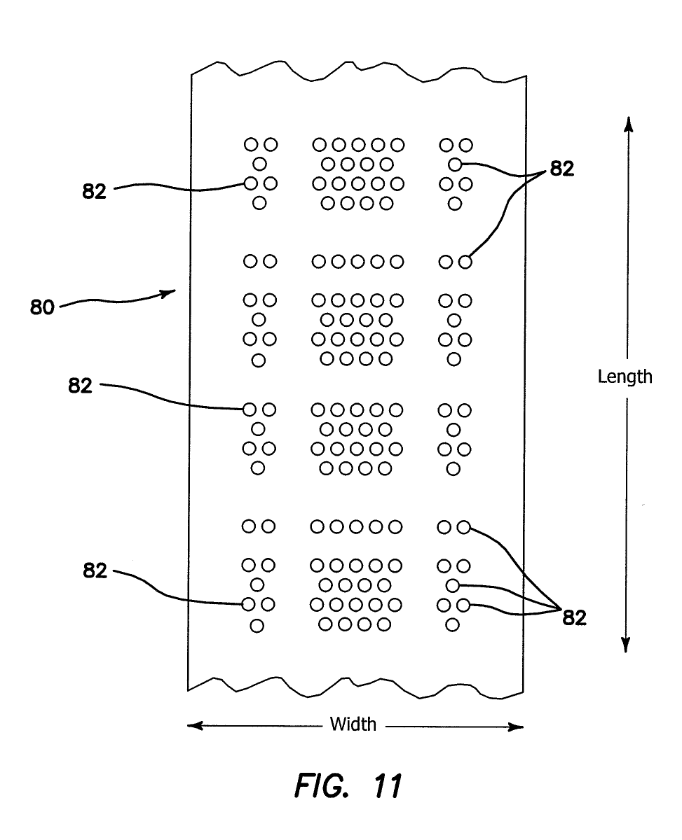

In one example, a tubular element or bag has substantially the same overall dimensions as the tubular element 810 in FIG. 8. In this example, not shown in FIG. 8, 138 holes are punched, for example, pneumatically punched, through an elongated sheet of polymeric, e.g., polyolefin, material which is 13 inches wide. In FIG. 11, a portion of such an elongated sheet 80 is shown. This elongated sheet 80 is drawn through a processing station including pneumatically powered punches which make 69 holes 82 at a time in the sheet. The punches are cycled (or used) twice as the sheet advances to produce a sheet portion including 138 holes 82 in an arrangement or pattern substantially as shown in FIG. 11. Each of the holes is about one quarter (¼) inch in diameter. Substantially the same staggered arrangement or pattern of 138 holes are punched in other portions of elongated sheet 80, with each such portion ultimately being used to form a tubular element or bag.

After the holes 82 are punched as shown in FIG. 11, the elongated sheet 80 is drawn around an appropriately shaped mandrill that forms the sheet into a tube by overlapping the sides along the length of the sheet by about one inch. The mandrill then heat seals a seam in the overlapped sides of the sheet which forms a tube which, when flattened, is about 6 inches wide.

The tube is pulled partially off the mandrill and the bottom of the tube is seamed (sealed) by an additional heat sealer. Using the mandrill as a funnel, tablets or pellets of the additive composition are dropped into the tube. The filled section of the tube is drawn off the mandrill and the top of the section of the tube is sealed, for example, by the additional heat sealer. In addition, the filled section of the tube is cut free from the remainder of the tube, thereby providing a tubular element or bag filled with the additive composition, and a new bottom of the tube is seamed (sealed) by the additional heat sealer.

This process is repeated until the desired number of additive composition filled tubular elements or bags are provided.

In one example, a tubular element or bag produced as set forth above, including 138 holes, has a diameter of about 3.8 inches and holds about 2.5 pounds of the additive composition. About 6.3% of the surface of the bag (which bag has a total surface area of about 106 square inches) which holds the pellets or tablets of the additive composition is open because of the presence of the holes.

In producing smaller tubular elements or bags, a substantially similar method may be used. With the smaller tubular elements or bags, the punches may be cycled or used only once, and the tubular elements or bags may be about half as long as the larger tubular elements or bags noted above.

In one example, the smaller tubular element or bag includes 69 holes in a staggered arrangement or pattern including 5 rows of 9 holes and 4 rows of 6 holes, with each of the 6 hole rows being located between two of the 9 hole rows. Such smaller bags have about 6.0% of the surface of the bag which holds the pellets or tablets of the additive composition open because of the presence of the holes, and hold about 1 pound of the additive composition.

In one example and without limitation, the additive composition-containing tubular elements and bags of the present invention may be provided using fill and seal machines, such as those, including one or more modified versions thereof, sold by Pacmac Inc.

The amount of coating on the pellets or tablets may be adjusted, as desired, to take into account the amount of open area created by the presence of the holes. For example, with all other factors remaining constant, an increase in the open area may result in an increased amount of coating to maintain the same amount of additive release; while a decrease in the open area may result in a decreased amount of coating to maintain the same amount of additive release.

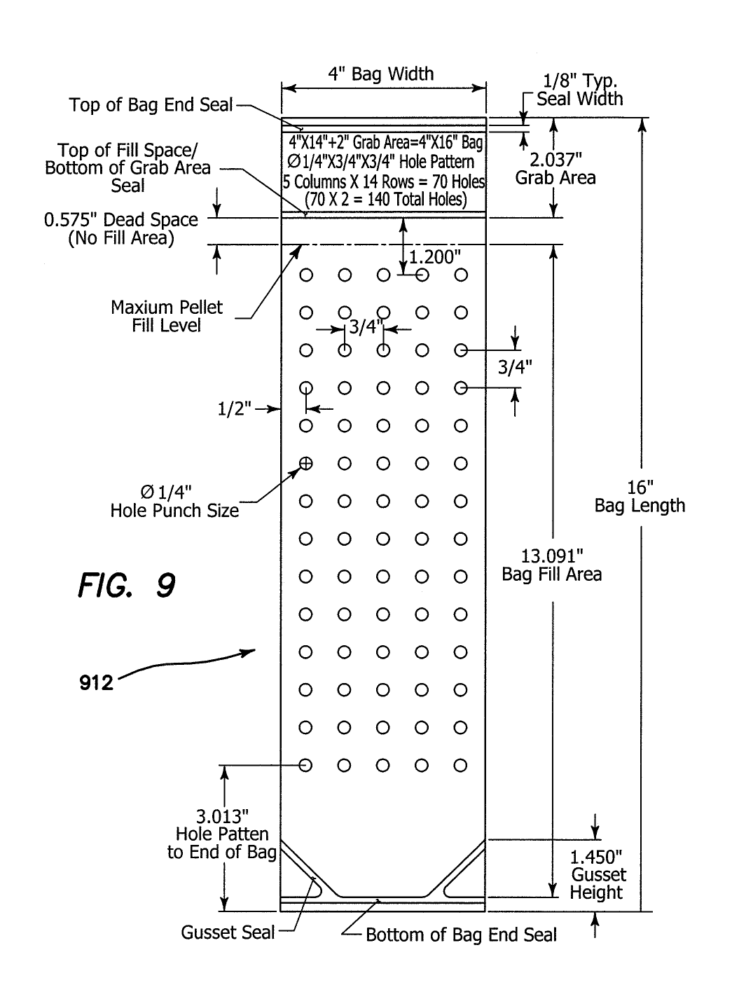

The tubular element 912 in FIG. 9 may be considered Option 3.

In Option 3, the through hole patterns is relatively far (relative to Option 1) from the bottom end of the tubular element or bag; and the dead space between the top of the pellets or tablets and the top of the fill space of the tubular element or bag is smaller relative to Option 1.

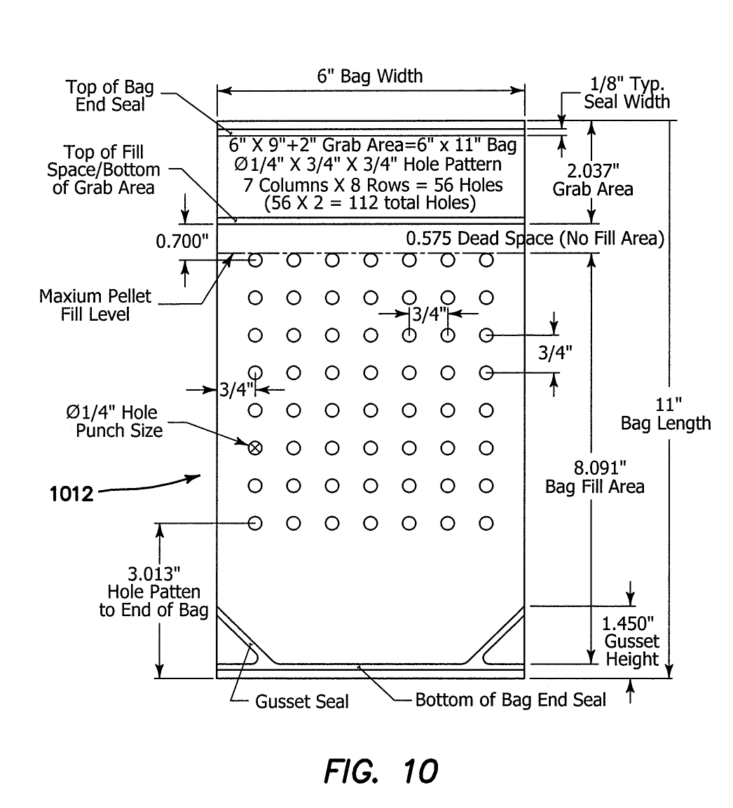

The tubular element 1012 in FIG. 10 may be considered Option 4.

Option 4 is similar to Option 3, except that the width of the tubular element or bag is larger than in Option 3 and the length of the tubular element or bag is smaller than in Option 3.

In each of the examples set forth herein, for example, in FIGS. 7-11, the ¾ inch by ¾ inch hole patterns or spacings can be changed, for example, as noted above, to more effectively meet the needs or demands of the particular application in which the tubular element is to be used. All dimensions of the present tubular elements, for example, tubular elements 712, 812, 912 and 1012, are subject to change, for example, to more effectively satisfy the needs or demands of the particular application in which the tubular element is to be used.

FIGS. 7-11 are provided to illustrate specific examples, for example, non-limiting examples, of the size of the tubular element, the number, size and placement of the through holes in the tubular elements, the placement of the end seals, the inclusion of grab areas, which make it easier to handle the tubular elements when they are filled with coated items and sealed, and other features of tubular elements 710, 810, 910 and 1010, which are shown and/or described herein.

While this invention has been described with respect to various specific examples and embodiments, it is to be understood that the invention is not limited thereto and that it can be variously practiced within the scope of the following claims.

What is claimed is:

1. A system for releasing an additive component, the system comprising:
a plurality of coated items comprising a core comprising an additive component effective to treat a liquid medium when released into the liquid medium, and a coating substantially surrounding the core and effective to slow the release of the additive component into the liquid medium, the coating being substantially insoluble in the liquid medium; and
a container holding the plurality of coated items, the container comprising a material substantially insoluble in the liquid medium and a plurality of through holes through the material, the material covers an area of the container greater than the combined area of the plurality of through holes, the release rate of the additive component from the plurality of coated items into a liquid medium in contact with the container is more uniform over time relative to a reference release rate of an identical additive component from an identical plurality of identical coated items held in an identical container in which the material covers an area of the container less than the combined area of the plurality of through holes.

2. The system of claim 1, wherein the material covers an area of the container at least about 1.5 times the combined area of the plurality of through holes.

3. The system of claim 1, wherein the material covers an area of the container at least about 2 times the combined area of the plurality of through holes.

4. The system of claim 1, wherein the plurality of through holes comprises at least about 5 through holes.

5. The system of claim 1, wherein the plurality of through holes comprises at least about 20 through holes.

6. The system of claim 1, wherein the plurality of through holes are sized to prevent the plurality of coated items from passing out of the container through the through holes.

7. The system of claim 1, wherein the area of each of the plurality of through holes is less than the average minimum cross-section area of the plurality of coated items.

8. The system of claim 1, wherein the average area of the plurality of through holes is at least about 0.1 square inch.

9. The system of claim 1, wherein the average area of the plurality of through holes is at least about 0.2 square inch.

10. The system of claim 1, wherein the container includes no more than about 6 through holes per square inch of container.

11. The system of claim 1, wherein, except for the plurality of through holes, the container is closed.

12. A system for releasing an additive component, the system comprising:
a plurality of coated items comprising a core comprising an additive component effective to treat a liquid medium when released into the liquid medium, and a coating substantially surrounding the core and effective to slow the release of the additive component into the liquid medium, the coating being substantially insoluble in the liquid medium; and
a container holding the plurality of coated items, the container comprising a material insoluble in the liquid medium and a plurality of through holes the average area of the plurality of through holes is at least about 0.1 square inch.

13. The system of claim 12, wherein the average area of the plurality of through holes is at least about 0.2 square inch.

14. The system of claim 12, wherein the plurality of through holes comprises at least about 5 through holes.

15. The system of claim 12, wherein the plurality of through holes comprises at least about 20 through holes.

16. The system of claim 12, wherein the container includes no more than about 6 through holes per square inch of container.

17. The system of claim 12, wherein the material covers an area of the container at least about 1.5 times the combined area of the plurality of through holes.

18. The system of claim 12, wherein the material covers an area of the container at least about 2 times the combined area of the plurality of through holes.

19. The system of claim 12, wherein except for the plurality of through holes, the container is closed.

20. A method for releasing an additive component, the method comprising:
contacting the container of claim 1 with a liquid medium, thereby releasing the additive component into the liquid medium.
